(19) United States
(12) Patent Application Publication
(10) Pub. No.: US 2025/0026368 A1
(43) Pub. Date: Jan. 23, 2025

(54) AUTONOMOUS VEHICLE TRAJECTORY PLANNING USING NEURAL NETWORK TRAINED BASED ON KNOWLEDGE DISTILLATION

(71) Applicant: Honda Motor Co., Ltd., Tokyo (JP)

(72) Inventors: DAVID ISELE, SUNNYVALE, CA (US); SANGJAE BAE, SAN JOSE, CA (US); PIYUSH GUPTA, MILPITAS, CA (US)

(21) Appl. No.: 18/531,510

(22) Filed: Dec. 6, 2023

Related U.S. Application Data
(60) Provisional application No. 63/514,764, filed on Jul. 20, 2023.

(51) Int. Cl. B60W 60/00; B60W 50/00; G06N 3/08

(52) U.S. Cl. CPC B60W 60/001; B60W 50/0097; G06N 3/08; B60W 2520/06; B60W 2520/10; B60W 2520/105

(57) ABSTRACT

An electronic device and a method for AV trajectory planning using neural networks trained based on knowledge distillation is provided. A set of updated values of a set of variables of an objective function for trajectory planning of an ego AV are determined. A first prediction network is applied on an updated value of the set of updated values, a states of the ego AV and a set of AVs over a past time interval. Based on the application, an output is determined. The output includes states of the ego AV and set of AVs over a future time interval. The electronic device determines a set of optimal values based on the updated value and the determined output satisfying a safety constraint associated with the objective function. Further, the electronic device controls a trajectory of the ego AV based on the set of optimal values of the set of variables.

### RELATED APPLICATIONS

This patent application is related to U.S. Provisional Application No. 63/514,764 filed Jul. 20, 2023, entitled “Unlocking Efficiency & Scalability: Harnessing Knowledge Distillation for Neural Network-Based Constrained Optimization”, in the names of the same inventors which is incorporated herein by reference in its entirety. The present patent application claims the benefit under 35 U.S.C § 119(e) of the aforementioned provisional application.

### BACKGROUND

Advancements in the fields of artificial intelligence have led to the development of data-driven approaches that may employ machine learning models for performance of challenging tasks associated with various engineering applications (for example, robotic manipulation). Although representation of such tasks using simple mathematical models may be increasingly cumbersome and/or erroneous, the usage of the machine learning models allow performance of such tasks with remarkable efficiency and accuracy. For example, neural networks may be used for accomplishing complex objectives (such as object detection, object tracking, traffic prediction, and so on) for engineering applications such as robotic manipulation or autonomous driving. However, application of the machine learning models for safety-critical tasks may be restricted due to lack of robust security guarantees, despite reduced latency and higher accuracy offered by the machine learning models. Therefore, the machine learning models may be integrated with optimization-based systems where controllers may apply the machine learning models for solving constrained optimization problems. However, solving constrained optimization problems using the machine learning models may be challenging due to inherent non-convexity and complexity of the machine learning models. Further, irrespective of the convexity, usage of the machine learning models for solving the constrained optimization problems in real-time applications may be infeasible.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device for autonomous vehicle (AV) trajectory planning using neural networks trained based on knowledge distillation is provided. The electronic device may include circuitry, which may be configured to determine a set of updated values of a set of variables of an objective function for trajectory planning of an ego AV. The determination may be based on a set of initial values of the set of variables and a set of gradients of the objective function. The circuitry may be further configured to apply the first prediction network on an updated value of the set of updated values, a state of the ego AV over a past time interval, and a state of each AV of a set of AVs over the past time interval. The updated value may be indicative of a current state of the ego AV. The circuitry may be further configured to determine, based on the application, an output that includes a state of the ego AV over a future time interval, and a state of each AV of the set of AVs over the future time interval. The circuitry may be further configured to determine a set of optimal values based on the updated value and the determined output satisfying a safety constraint associated with the objective function. The circuitry may be further configured to control a trajectory of the ego AV based on the set of optimal values of the set of variables.

According to another embodiment of the disclosure, a method for AV trajectory planning using neural networks trained based on knowledge distillation is provided. The method may include determining a set of updated values of a set of variables of an objective function for trajectory planning of an ego AV. The determination may be based on a set of initial values of the set of variables and a set of gradients of the objective function. The method may further include applying the first prediction network on an updated value of the set of updated values, a state of the ego AV over a past time interval, and a state of each AV of a set of AVs over the past time interval. The updated value may be indicative of a current state of the ego AV. The method may further include determining, based on the application, an output that includes a state of the ego AV over a future time interval, and a state of each AV of the set of AVs over the future time interval. The method may further include determining a set of optimal values based on the set of updated values and the determined output satisfying a safety constraint associated with the objective function. The method may further include controlling a trajectory of the ego AV based on the set of optimal values of the set of variables.

According to another embodiment of the disclosure, a non-transitory computer-readable medium is provided. The non-transitory computer-readable medium may have stored thereon computer implemented instructions that, when executed by an electronic device, causes the electronic device to execute operations. The operations may include determining a set of updated values of a set of variables of an objective function for trajectory planning of an ego AV. The determination may be based on a set of initial values of the set of variables and a set of gradients of the objective function. The operations may further include applying the first prediction network on an updated value of the set of updated values, a state of the ego AV over a past time interval, and a state of each AV of a set of AVs over the past time interval. The updated value may be indicative of a current state of the ego AV. The operations may further include determining, based on the application, an output that includes a state of the ego AV over a future time interval, and a state of each AV of the set of AVs over the future time interval. The operations may further include determining a set of optimal values based on the set of updated values and the determined output satisfying a safety constraint associated with the objective function. The operations may further include controlling a trajectory of the ego AV based on the set of optimal values of the set of variables.

### BRIEF DESCRIPTION OF THE DRAWINGS

FIG. 1 is a diagram that illustrates an exemplary network environment for autonomous vehicle (AV) trajectory planning using neural networks trained based on knowledge distillation, in accordance with an embodiment of the disclosure.

FIG. 2 is a block diagram that illustrates an exemplary electronic device of FIG. 1, AV trajectory planning using neural networks trained based on knowledge distillation, in accordance with an embodiment of the disclosure.

FIG. 3 is a diagram that illustrates an exemplary teacher prediction network for generation of a set of predictions associated with states of an ego AV and a set of AVs interacting with the ego AV, in accordance with an embodiment of the disclosure.

FIG. 4 is a block diagram of a scenario for exemplary knowledge distillation used for training a student prediction network using a set of predictions that may be generated by a teacher prediction network, in accordance with an embodiment of the disclosure.

FIG. 5 is a diagram that illustrates an exemplary student prediction network for generation of predictions of a state of an ego AV and a set of AVs interacting with the ego AV over a future time interval, in accordance with an embodiment of the disclosure.

FIG. 6 is a flowchart that illustrates exemplary operations for AV trajectory planning using neural networks trained based on knowledge distillation, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic device and method for autonomous vehicle (AV) trajectory planning using neural networks trained based on knowledge distillation. Exemplary aspects of the disclosure may provide an electronic device that may be included in an ego AV (such as a car or a truck). Initially, a set of initial values of a set of variables (i.e., optimization variables that include steering, acceleration, and state trajectories) of an objective function may be received. The objective function may be associated with trajectory planning of the ego AV. The objective function may be required to be minimized based on determination of a set of optimal values for the set of variables of the objective function. Specifically, the electronic device may be configured to determine a set of updated values of the set of variables based on the set of initial values and a set of gradients (determined with respect to the set of variables) of the objective function. A first prediction network (such as a low complexity student prediction network that may be compact, efficient, and function as an interactive prediction network) may be trained based on knowledge distillation. The knowledge distillation may involve using a set of predictions of a pre-trained second prediction network (such as a larger teacher prediction network compared to the student prediction network). The set of predictions may include a state of the ego AV over a predefined time interval and a state of each AV of a set of AVs interacting with the ego AV over the predefined time interval. The electronic device may be further configured to apply the (trained) first prediction network on an updated value of the set of updated values, a state of the ego AV over a past time interval, and a state of each AV of the set of AVs over the past time interval. The updated value (on which the first prediction network may be applied) may be indicative of a current state of the ego AV. The electronic device may be further configured to determine, based on the application of the student prediction network, an output that may include a state of the ego AV over a future time interval and a state of each AV of the set of AVs over the future time interval. The electronic device may be further configured to determine a set of optimal values based on the set of updated values and the determined output satisfying a safety constraint (for the ego AV with respect to the set of AVs) associated with the objective function. The objective function may converge to a global minimum value based on the determination of the set of optimal values. The electronic device may be further configured to control a trajectory of the ego AV based on the set of optimal values of the set of variables.

Data-driven approaches leverage machine learning models for performance of challenging tasks, whose representation using simple mathematical models may be difficult. The machine learning models may enable execution of the tasks with a greater efficiency, speed, and accuracy. However, usage of machine learning models in safety-critical tasks may be restricted due to lack of robust safety guarantees. For example, in autonomous driving, the machine learning models may be used for upstream tasks (such as perception or prediction) while classical optimization-based control techniques may be used for downstream tasks due to explicit modeling of safety and dynamic constraints in optimization. Therefore, machine learning models may be integrated with optimization-based systems to enable solutions of constrained optimization problems with the machine learning models. However, the integration of the machine learning models with classical optimization systems for solving constrained optimization problems may pose challenges such as increased computational complexity and requirement for reliance on of heuristic methods. This may be due to non-convexity of machine learning models and complexity of structures of the machine learning models. For instance, the machine learning models may be employed as black-box models within optimization scenarios due to an absence of explicit mathematical architecture of the machine learning models. Further, in some scenarios, requirement of unique architectural modification may necessitate design of custom machine learning models.

To address the aforementioned issues, the disclosed electronic device and method may leverage knowledge distillation whereby knowledge or learnings associated with a larger (and pre-trained) teacher prediction network (i.e., the second prediction network) may be used to train a smaller student prediction network (i.e., the first prediction network). Knowledge distillation may enable a consolidation of the knowledge encapsulated in the teacher prediction network based on distillation of the knowledge and facilitate building the student prediction network that is light, compact, and efficient. The architecture of the student prediction network may be simple, and, hence, the student prediction network may be appropriate for integration with classical optimization-based systems (such as, an optimization-based AV trajectory planner). The student prediction network may be a simplified version of a machine learning-based non-linear programming problem solver that may be used for solving constrained non-convex optimization problems in real-time and generate locally optimal solutions without trading-off with accuracy. The student prediction network may be designed such that generation of optimal solutions is accelerated and problem-solving efficacy of the student prediction network is at par with larger prediction networks (such as, the teacher prediction network).

The student prediction network may be an interactive prediction network that may be capable of predicting, in a single inference, an impact of a trajectory of an ego AV on a set of AVs that may be in vicinity of the ego AV, over a planning horizon. The trajectory of the ego AV may be based on a set of variables whose values may be required to be optimized based on minimization of an objective function. At each iteration, the values of the set of variables may constitute a candidate solution or a candidate trajectory for the ego AV. The student prediction network may receive the candidate trajectory as input, and predict, as output (in a single inference), trajectories of the ego AV and each AV of the set of AVs. The impact of the trajectory of the ego AV on the set of AVs may be indicated in the output. Based on the output, values of the set of variables may be updated based on satisfaction of a safety constraint for the ego AV with respect to the set of AVs. If the values are determined as optimal values, the trajectory of the ego AV may be controlled by the electronic device based on the optimal values of the set of variables.

Reference will now be made in detail to specific aspects or features, examples of which are illustrated in the accompanying drawings. Wherever possible, corresponding, or similar reference numbers will be used throughout the drawings to refer to the same or corresponding parts.

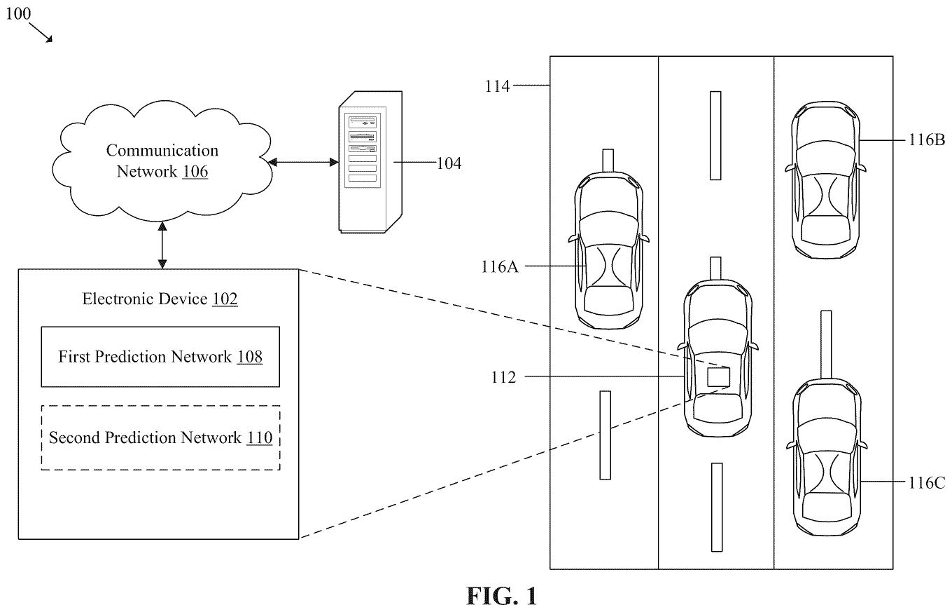

FIG. 1 is a diagram that illustrates an exemplary network environment for autonomous vehicle (AV) trajectory planning using neural networks trained based on knowledge distillation, in accordance with an embodiment of the disclosure. With reference to FIG. 1, there is shown a diagram of a network environment diagram 100. The network environment 100 includes an electronic device 102 and a server 104. The electronic device 102 and the server 104 via a communication network (such as a communication network 106). The electronic device 102 may include a first prediction network 108. In at least one embodiment, the electronic device 102 may include a second prediction network 110. In at least one embodiment, the electronic device 102 may be included in an ego AV 112. In some embodiments, the electronic device 102 may be used to remotely control the ego AV 112. The ego AV 112 may be included in a scene 114, for example, a road portion. The scene 114 may further include a set of AVs 116. The set of AVs 116 may include a first AV 116A, a second AV 116B, and a third AV 116C, as exemplary AVs in the set of AVs 116. The scene 114 may also include objects, such as, but not limited to, roads, traffic signals, sign boards, trees, humans/animals, and so forth. Such objects are not shown in FIG. 1, for the sake of brevity. In the scene 114, each of the ego AV 112, the first AV 116A, the second AV 116B, and the third AV 116C, are shown as four-wheeler cars; however, the disclosure may not be so limiting. In accordance with an embodiment, each of the ego AV 112, the first AV 116A, the second AV 116B, and the third AV 116C may be any vehicle, such as, a jeep, a truck, or a bus. The scene 114 in FIG. 1 is shown to include three AVs (i.e., the set of AVs 116) merely as an example. The set of AVs 116 may include only one or more than three AVs without deviation from the scope of the disclosure.

The electronic device 102 may include suitable logic, circuitry, interfaces, and/or code that may be configured to receive a set of initial values of a set of variables of an objective function (to be minimized) associated with trajectory planning of the ego AV 112. The electronic device 102 may be further configured to determine a set of updated values of the set of variables based on the set of initial values and a set of gradients of the objective function. The electronic device 102 may be further configured to apply the first prediction network 108 on an updated value of the set of updated values that corresponds to a current state of the ego AV 112, and states of the ego AV 112 and each AV of the set of AVs 116 over a past time interval. The electronic device 102 may determine, based on the application, an output that includes a state of the ego AV 112 over a future time interval and a state of each AV of the set of AVs 116 over the future time interval. The electronic device 102 may be further configured to determine a set of optimal values for the set of variables, based on the updated value and the output satisfying a safety constraint associated with the objective function. The electronic device 102 may be further configured to control a trajectory of the ego AV 112 based on the set of optimal values of the set of variables.

In accordance with an embodiment, the electronic device 102 may function as an electronic control device (ECU) of the ego AV 112. The electronic device 102 (i.e., the ECU) may include an ECU processor that may control different functions of the electronic device 102 and the ego AV 112. Examples of the electronic device 102 may include, but are not limited to, a microprocessor, a vehicle control system, an in-vehicle infotainment (IVI) system, an in-car entertainment (ICE) system, an Advanced Driver Assistance System (ADAS), an automotive Head-up Display (HUD), an automotive dashboard, an embedded device, a smartphone, a human-machine interface (HMI), a computer workstation, a handheld computer, a portable consumer electronic (CE) device, a server, and other computing devices.

The server 104 may include suitable logic, circuitry, interfaces, and/or code that may be configured to transmit control instructions to the electronic device 102 to control the trajectory of the ego AV 112. In at least one embodiment, the server 104 may receive the set of updated values of the set of variables of the objective function from the electronic device 102. The server 104 may apply the first prediction network 108 on an updated value of the set of updated values, and states of the ego AV 112 and each AV of the set of AVs 116 over a past time interval. Herein, the updated value of the set of updated values may correspond to a current state of the ego AV 112. The server 104 may further determine, based on the application, an output that includes a state of the ego AV 112 over a future time interval and a state of each AV of the set of AVs 116 over the future time interval. The server 104 may determine a set of optimal values for the set of variables, based on the output satisfying a safety constraint associated with the objective function and the minimization of the objective function based on the set of optimal values. The server 104 may transmit the set of optimal values to the electronic device 102 such that a trajectory of the ego AV 112 may be controlled based on the set of optimal values of the set of variables. The server 104 may execute operations through web applications, cloud applications, HTTP requests, repository operations, file transfer, and the like. Example implementations of the server 104 may include a database server, a file server, a web server, an application server, a mainframe server, a cloud computing server, or a combination thereof.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102 as two separate entities. In certain embodiments, the functionalities of the server 104 may be incorporated in its entirety or at least partially in the electronic device 102 without a departure from the scope of the disclosure.

The communication network 106 may correspond to a communication medium through which the electronic device 102 and the server 104 may communicate with each other. The communication network 106 may be a wireless connection. Examples of the communication network 106 may include, but may not be limited to, the Internet, a wireless fidelity (Wi-Fi) network, a personal area network (PAN), a metropolitan area network (PAN), a cellular network (such as, a 4^{th} Generation (4G) Long-Term Evolution network or a 5^{th} Generation (5G) network), a satellite network (including a network of a set of low earth orbit (LEO) satellites and a set of ground stations wirelessly connected to the set of LEO satellites), or a cloud network. The electronic device 102 and the server 104 may be configured to connect to the communication network 106 in accordance with a wireless communication protocol. Examples of the wireless communication protocol may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, Enhanced Data for GSM (Global System for Mobile communication) Evolution (EDGE), Institute of Electrical and Electronics Engineers (IEEE) 802.11, light fidelity (Li-Fi), IEEE 802.16, IEEE 802.11s, IEEE 802.11g, device-to-device (D2D) communication, Bluetooth communication protocol, wireless access point (AP), multi-hop communication, or cellular communication protocols.

Each of the first prediction network 108 and the second prediction network 110 may be a neural network-based model and may be referred to as a neural network. The neural network may be a computational network or a system of artificial neurons that may typically be arranged in a plurality of layers. The neural network may be defined by its hyper-parameters, for example, activation function(s), a number of weights, a cost function, a regularization function, an input size, a number of layers, and the like. Further, the layers may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Each node in the final layer may be connected with each node of the pre-final layer. Each node in the final layer may receive inputs from the pre-final layer to output a result. The number of layers and the number of nodes in each layer may be determined from the hyper-parameters of the neural network. Such hyper-parameters may be set before or after training of the neural network.

Each node may correspond to a mathematical function (e.g., a sigmoid function or a rectified linear unit) with parameters that are tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function. In training of the neural network, one or more parameters of each node of the neural network may be updated based on whether an output of the final layer for a given input (from the training dataset) matches a correct result in accordance with a loss function for the neural network. The above process may be repeated for the same or a different input until a minimum of the loss function is achieved, and a training error is minimized. Several methods for training are known in art, for example, gradient descent, stochastic gradient descent, batch gradient descent, gradient boost, meta-heuristics, and the like.

The first prediction network 108 may be a machine learning model that may be build based on distillation of knowledge encapsulated in the second prediction network 110. The first prediction network 108 may be a compact neural network-based model with a simplified structure. The first prediction network 108 may be an efficient network that may be capable of updating the state of the ego AV 112 to minimize an objective function associated with an optimization problem related to trajectory planning of the ego AV 112. The state of the ego AV 112 may constitute a trajectory parameter of the ego AV 112 and an optimum value of the state of the ego AV 112 may be required to be determined for minimization of the objective function. The first prediction network 108 may be trained to predict a trajectory (i.e., a state) of the ego AV 112 over a future time interval and an influence of the predicted trajectory of the ego AV 112 on the set of AVs 116 over the future time interval in a single inference. The simultaneous prediction of the trajectory of the ego AV 112 and the influence of the predicted trajectory on the set of AVs 116 over the future time interval in the single inference iteration may enable a reduction of computational complexity of the optimization problem and determination of the optimum trajectory in real-time.

The first prediction network 108 may be configured to receive inputs that include a state of the ego AV 112 over a past time interval, a state of each AV of the set of AVs 116 over the past time interval, and a candidate trajectory of the ego AV 112 (i.e., the state of the ego AV 112) determined at a current time instant. In at least one embodiment, the first prediction network 108 may include an encoder model and a decoder model. In an embodiment, each of the encoder model and the decoder model may include a set of recurrent neural network models. The encoder model may receive the inputs and the decoder model may generate, as outputs, the predicted trajectory (i.e., the state) of the ego AV 112 over the future time interval and predicted trajectories (i.e., states) of each AV of the set of AVs 116 over the future time interval. The first prediction network 108 may be trained based on predictions generated by the second prediction network 110.

The second prediction network 110 may be a machine learning model that may be trained to predict the state of the ego AV 112 over a predefined time interval and the state of each AV of the set of AVs 116 over the predefined time interval. The second prediction network 110 may be a larger model as compared to the first prediction network 108 and knowledge encapsulated in the second prediction network 110 may be distilled for training the first prediction network 108. The second prediction network 110 may generate a set of predictions at a set of time steps during elapsing of the predefined time interval. The generation of a prediction for each time step of the set of time steps may be based on reception, by the second prediction network 110, of inputs that include the states of the ego AV 112 at a set of past time steps relative to the corresponding time step and states of each AV of the set of AVs 116 at the set of past time steps.

In accordance with an embodiment, each of the first prediction network 108 and the second prediction network 110 may include electronic data. The electronic data may be implemented as a software component of an application that may be executable on the electronic device 102. Each of the first prediction network 108 and the second prediction network 110 may rely on one or more of libraries, logic/instructions, or external scripts, for execution by a processing device included in the electronic device 102. In one or more embodiments, each of the first prediction network 108 and the second prediction network 110 may be implemented using hardware that may include a processor, a microprocessor (for example, to perform or control performance of one or more operations), a Field-Programmable Gate Array (FPGA), or an application-specific integrated circuit (ASIC). Alternatively, in some embodiments, each of the first prediction network 108 and the second prediction network 110 may be implemented using a combination of hardware and software. Examples of the first prediction network 108 and the second prediction network 110 may include, but are not limited to, a recurrent neural network (RNN), a CNN-RNN, R-CNN, Fast R-CNN, Faster R-CNN, an artificial neural network (ANN), (You Only Look Once) YOLO network, a Long Short Term Memory (LSTM) network based RNN, CNN+ANN, LSTM+ANN, a gated recurrent unit (GRU)-based RNN, a Connectionist Temporal Classification (CTC) based RNN, a deep Bayesian neural network, a Generative Adversarial Network (GAN), and/or a combination of such networks. In some embodiments, the each of the first prediction network 108 and the second prediction network 110 may be based on a hybrid architecture of DNNs.

The ego AV 112 and each AV (i.e., each of the first AV 116A, the second AV 116B, and the third AV 116C) of the set of AVs 116 may be referred to as an AV. The AV may be a semi-autonomous vehicle or a fully autonomous vehicle. Examples of the AV may include, but are not limited to, a four-wheeler vehicle, a three-wheeler vehicle, or a hybrid vehicle, that uses one or more distinct renewable or non-renewable power sources. Examples of the four-wheeler vehicle may include, but are not limited to, an electric car, an internal combustion engine (ICE)-based car, a fuel-cell based car, a solar powered-car, or a hybrid car. The description of other types of the vehicles has been omitted from the disclosure for the sake of brevity.

In operation, the electronic device 102 may be configured to determine a set of updated values of a set of variables of an objective function for trajectory planning of the ego AV 112. The determination of the set of updated values may be based on a set of initial values of the set of variables and a set of gradients of the objective function. The electronic device 102 may receive the set of initial values of the set of variables. The set of variables of the objective function may be associated with trajectory planning of the ego AV 112 and may, thus, include multiple trajectory parameters of the ego AV 112. The objective function may be associated with an optimization problem that may involve a determination of an optimized trajectory for the ego AV 112. The optimization problem may be solved based on determination of a set of optimum values for the set of variables of the objective function. The trajectory planning may be interaction-aware, i.e., the set of optimum values of the set of variables may be determined based on trajectory parameters of each AV of the set of AVs 116 that may be in vicinity of the ego AV 112.

In accordance with an embodiment, the set of variables may include at least one of a steering trajectory, an acceleration trajectory, and a state trajectory. The state trajectory (i.e., the state of the ego AV 112) may include location coordinates (such as, X-Y coordinates) of the ego AV 112, a heading angle of the ego AV 112, and a speed of the ego AV 112. The objective function may be required to be minimized in a plurality of iterations such that a value of the objective function converges to a global minimum value. The convergence of the objective function to the global minimum value may be dependent on determination an optimal value for each variable of the set of variables such that a safety constraint associated with the objective function is satisfied. The optimal value for each variable may be determined after execution of the plurality of iterations of the objective function. At each iteration of the objective function, a candidate trajectory (i.e., a candidate solution) may be determined. The candidate trajectory may include values of the set of variables (i.e., values of the steering trajectory, the acceleration trajectory, and the state trajectory). The values of the set of variables (i.e., the candidate trajectory) determined after the plurality of iterations, such that the safety constraint is met and the objective function is minimized, may be the set of optimum values.

In an embodiment, the objective function may be formulated as given below in equation (1):

$$Objective Function ( J ) = min ( φ ( Δ ) + φ ( α ) + φ ( Z ) ) \qquad ( 1 )$$

The steering trajectory may be represented as “Δ”, the acceleration trajectory may be represented as “α”, and the state trajectory (i.e., the state of the ego AV 112) may be represented as “Z”. The function “φ” may be a quadratic function. At each iteration, a candidate trajectory corresponding to values of “Δ”, “α”, and “Z” may be determined. For instance, the set of initial values may include “Δ_{INITIAL}”, “α_{INITIAL}”, and “Z_{INITIAL}”. Based on the initial values the objective function may be determined. The values of the set of variables may be updated based on a determination that the objective function has not converged to the global minimum value. In accordance with an embodiment, the electronic device 102 may compute the set of gradients of the objective function for determination of the set of updated values. The set of gradients may include a first gradient, a second gradient, and a third gradient. The first gradient may be determined with respect to a first variable of the set of variables. Similarly, the second gradient and the third gradient may be determined with respect to a second variable of the set of variables and a third variable of the set of variables, respectively. The first gradient, the second gradient, and the third gradient may be determined with respect to a derivative (for example, a partial derivative) of the objective function with respect to “Δ”, “α”, and “Z”, respectively.

In an embodiment, the set of updated values of the set of variables may be determined based on the following equations (2), (3), and (4):

$${Δ}_{UPDATED} = {Δ}_{INITIAL} - θ \frac{\partial J}{\partial Δ} \qquad ( 2 )$$

$${α}_{UPDATED} = {α}_{INITIAL} - θ \frac{\partial J}{\partial α} \qquad ( 3 )$$

$${Z}_{UPDATED} = {Z}_{INITIAL} - θ \frac{\partial J}{\partial Z} \qquad ( 4 )$$

In equations (2), (3), and (4), “θ” may represent a learning parameter. A first updated value, i.e., “Δ_{UPDATED}”, of the set of updated values of the first variable (i.e., the steering trajectory of the ego AV 112) may be determined based on an initial value (i.e., “Δ_{INITIAL}”) of the set of initial values of the first variable and the first gradient (which may be represented as (“∂J/∂Δ”) of the set of gradients determined with respect to the first variable. Similarly, a second updated value (i.e., “α_{UPDATED}”) of the set of updated values of the second variable (i.e., the acceleration trajectory of the ego AV 112) may be determined based on an initial value (i.e., “α_{INITIAL}”) of the set of initial values of the second variable and the second gradient (which may be represented as (“∂J/∂α”) of the set of gradients determined with respect to the second variable. Further, a third updated value (i.e., “Z_{UPDATED}”) of the set of updated values of the third variable (i.e., the state of the ego AV 112) may be determined based on an initial value (i.e., “Z_{INITIAL}”) of the set of initial values of the third variable and the second gradient (which may be represented as (“∂J/∂Z”) of the set of gradients determined with respect to the third variable.

The electronic device 102 may be further configured to apply the first prediction network 108 on an updated value of the set of updated values, a state of the ego AV 112 over a past time interval, and a state of each AV of the set of AVs 116 over the past time interval. The updated value may be indicative of a current state of the ego AV 112. The current state of the ego AV 112 (which may be represented as “Z_{CURRENT}”) may be the third updated value (i.e., “Z_{UPDATED}”). Thus, the applied updated value may be the third updated value. The past time interval may include a set of past time steps, which may immediately precede a current time instance of determination of the current state of the ego AV 112. The set of past time steps may include discrete time steps that may be located in a timeline corresponding to the past time interval.

The state of the ego AV 112 may be determined at each past time step of the set of past time steps. Similarly, the state of each AV (i.e., the first AV 116A, the second AV 116B, or the third AV 116C) of the set of AVs 116 may be determined at each past time step of the set of past time steps. In accordance with an embodiment, at the current time instance, a set of inputs may be fed to the first prediction network 108. The set of inputs may include “Z_{UPDATED}” (determined at the current time instance), the state of the ego AV 112 (i.e., state trajectory of the ego AV 112) determined at each past time step of the set of past time steps, the state of the first AV 116A determined at each past time step of the set of past time steps, the state of the second AV 116B determined at each past time step of the set of past time steps, and the state of the third AV 116C determined at each past time step of the set of past time steps.

The electronic device 102 may be further configured to determine, based on the application, an output that may include a state of the ego AV 112 over a future time interval and a state of each AV of the set of AVs 116 over the future time interval. The output may be generated in a single inference at the current time instance and during the elapse of the future time interval, based on the application of the first prediction network 108 on the set of inputs. The future time interval may include a set of future time steps. The future time interval may succeed the current time instance of determination of the current state of the ego AV 112. The set of future time steps may include discrete time steps located in a timeline corresponding to the future time interval. The first prediction network 108 may generate the output in portions, and the portions may be generated at the current time instance and at each future time step of the set of future time steps.

In accordance with an embodiment, the first prediction network 108 may include an encoder model and a decoder model. In an embodiment, each of the encoder model and the decoder model may include a set of recurrent neural network models. The first prediction network 108 may be configured to receive inputs that include a state of the ego AV 112 over a past time interval, a state of each AV of the set of AVs 116 over the past time interval, and a candidate trajectory of the ego AV 112 (i.e., the state of the ego AV 112) determined at a current time instant. The encoder model may receive the inputs and the decoder model may generate, as outputs, the predicted trajectory (i.e., the state) of the ego AV 112 over the future time interval and predicted trajectories (i.e., states) of each AV of the set of AVs 116 over the future time interval. The decoder model may generate a portion of the output at the current time instance and at each future time step of the set of future time steps. A first portion of the output, generated at the current time instance, may include a first prediction of the state of the ego AV 112 (i.e., a candidate solution) that is likely at a first future time step of the set of future time steps and a first prediction of the state of each AV (i.e., the first AV 116A, the second AV 116B, or the third AV 116C) of the set of AVs 116 that is likely at the first future time step. At the first future time step, the first prediction of the state of the ego AV 112 may constitute the (current) state of the ego AV 112. The decoder model may receive, as inputs, the first prediction of the state of the ego AV 112 and the first prediction of the state of each AV of the set of AVs 116. Based on the inputs, the decoder model may generate predictions (as a second portion of the output) at the first future time step. The second portion of the output may include a second prediction of the state of the ego AV 112 (i.e., a candidate solution) that is likely at the second time step and a second prediction state of each AV (i.e., the first AV 116A, the second AV 116B, or the third AV 116C) of the set of AVs 116 that is likely at the second future time step. Similarly, a final portion of the output may be generated, which may include predictions of the state of the ego AV 112 and the state of each AV of the set of AVs 116 that is likely at last future time step of the set of future time steps.

The electronic device 102 may be further configured to determine a set of optimal values for the set of variables of the objective function based on the updated value (i.e., the third updated value or “Z_{UPDATED}” indicative of the current state of the ego AV 112) and the determined output satisfying a safety constraint associated with the objective function. The first prediction network 108 may be integrated with the safety constraint for the ego AV 112 with respect to each AV (i.e., the first AV 116A, the second AV 116B, or the third AV 116C) of the set of AVs 116. The set of optimal values may be determined at the current time instance and each future time step of the set of future time steps (apart from the last time step of the set of future time steps).

At the current time instance, the electronic device 102 may determine that “Z_{UPDATED}” and the first prediction of the state of the ego AV 112 (the first portion of the output) may satisfy the safety constraint. Further, the “Z_{UPDATED}” and the first prediction of the state of each AV of the set of AVs 116 (the first portion of the output) may satisfy the safety constraint. Similarly, at the first future time step of the set of future time steps, the electronic device 102 may determine that the first prediction of the state of the ego AV 112 (the first portion of the output) and the second prediction of the state of the ego AV 112 (the second portion of the output) may satisfy the safety constraint. Further, the first prediction of the state of the ego AV 112 (the first portion of the output) and the second prediction of the state of each AV of the set of AVs 116 (the second portion of the output) may satisfy the safety constraint. Thus, the satisfaction of the safety constraint may be determined at the current time instance and each future time step of the set of future time steps (apart from the last time step of the set of future time steps).

Based on such determinations, the set of optimal values may be determined for the set of variables. In an embodiment, the set of optimal values may be determined as “Δ_{UPDATED}”, “α_{UPDATED}”, and “Z_{UPDATED}”, at the current time instance. The set of optimal values may be updated at each future time step of the set of future time steps (over the future time interval) based on the state of the ego AV 112 (i.e., “Z”) that may be predicted at the corresponding future time step. Further, Δ_{UPDATED}”, “α_{UPDATED}”, and the state of the ego AV 112 (determined at current time instance or predicted at each future time step) may be determined as the set of optimal values based on minimization of the objective function (see equation (1)) to a global minimum value.

The electronic device 102 may be further configured to control a trajectory of the ego AV 112 based on the set of optimal values of the set of variables. In accordance with an embodiment, controls of the ego AV 112 may be adjusted at the current time instance and each future time step of the set of future time steps based on the set of optimal values determined at the current time instance and each future time step of the set of future time steps. For example, a steering trajectory, an acceleration trajectory, location coordinates (such as, X-Y coordinates) of the ego AV 112, a heading angle of the ego AV 112, a speed of the ego AV 112 may be adjusted to control the trajectory of the ego AV 112. Thus, the trajectory of the ego AV 112 may be planned over the future time interval based on the set of optimal values constituting an optimized trajectory while meeting necessary safety criteria with respect to each AV of the set of AVs 116.

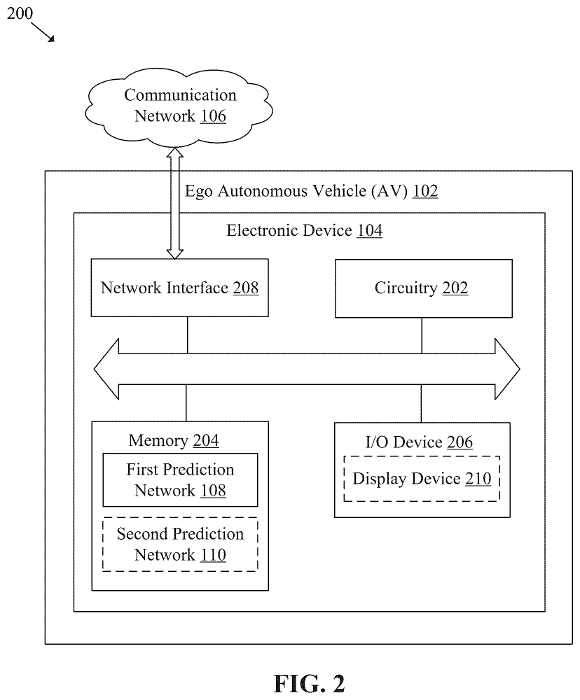

FIG. 2 is a block diagram that illustrates an exemplary electronic device of FIG. 1, AV trajectory planning using neural networks trained based on knowledge distillation, in accordance with an embodiment of the disclosure. FIG. 2 is explained in conjunction with elements from FIG. 1. With reference to FIG. 2, there is shown a block diagram 200 of the ego AV 112 including the electronic device 102. The electronic device 102 may include circuitry 202, a memory 204, an input/output (I/O) device 206, and a network interface 208. In at least one embodiment, the memory 204 may include the first prediction network 108 and the second prediction network 110. In at least one embodiment, the I/O device 206 may include a display device 210. The circuitry 202 may be communicatively coupled to the memory 204, the I/O device 206, and the network interface 208, through wired or wireless communication of the electronic device 102. Although in FIG. 2, it is shown that the electronic device 102 includes the circuitry 202, the memory 204, the I/O device 206, and the network interface 208; however, the disclosure may not be so limiting, and the electronic device 102 may include less or more components.

The circuitry 202 may include suitable logic, circuitry, and/or interfaces code that may be configured to execute program instructions associated with different operations to be executed by the electronic device 102. The set of operations may include, but are not limited to, determination of the set of updated values of the set of variables, application of the first prediction network 108, determination of the output, determination of a set of optimal values for the set of variables, and controlling of a trajectory of the ego AV 112. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform or direct performance of any number of operations of the electronic device 102, as described in the present disclosure. Examples of the circuitry 202 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the set of instructions executable by the circuitry 202. In at least one embodiment, the memory 204 may be configured to store the set of initial values of the set of variables of the objective function associated with trajectory planning of the ego AV 112, the set of updated values of the set of variables, and a set of gradients of the objective function. The memory 204 may be further configured to store updated values of each variable at each instance of determination of the candidate solution. The memory 204 may be further configured to store the state of the ego AV 112 and the state of each AV of the set of AVs 116 determined at each future time step over the future time interval. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The received input may include an instruction to determine an optimized trajectory for the ego AV 112. The output may include a set of optimal values determined for the set of variables. The I/O device 206 may include one or more input and output devices that may communicate with different components of the electronic device 102. Examples of the I/O device 206 may include, but are not limited to, a touch screen, a keyboard, a mouse, a joystick, a microphone, the display device 212, and a speaker.

The network interface 208 may include suitable logic, circuitry, and interfaces that may be configured to facilitate communication between the circuitry 202 and the server 104, via the communication network 106. The network interface 208 may be implemented by use of various known technologies to support wired communication or wireless communication of the electronic device 102 with the communication network 106. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, a wireless pear-to-pear protocol, a protocol for email, instant messaging, and a Short Message Service (SMS).

The I/O device 210 may include the display device 210. The display device 210 may include suitable logic, circuitry, and interfaces that may be configured to receive inputs from the circuitry 202 to render, on a display screen, the set of optimal values that may be determined for the set of variables. The display device 210 may be further configured to render the scene 114 that indicates a position (corresponding to location as included in the state (Z)) of the ego AV 112 relative to positions of each AV of the set of AVs 116 in the scene 114. For example, the display device 210 may correspond to at least one of a heads-up display (HUD), a head-mounted display (HMD), smart glasses, or augmented reality (AR)/virtual reality (VR)/mixed reality (MR) headsets that may be configured to render the scene 114 and a recommended trajectory for the control of the ego AV 112. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices.

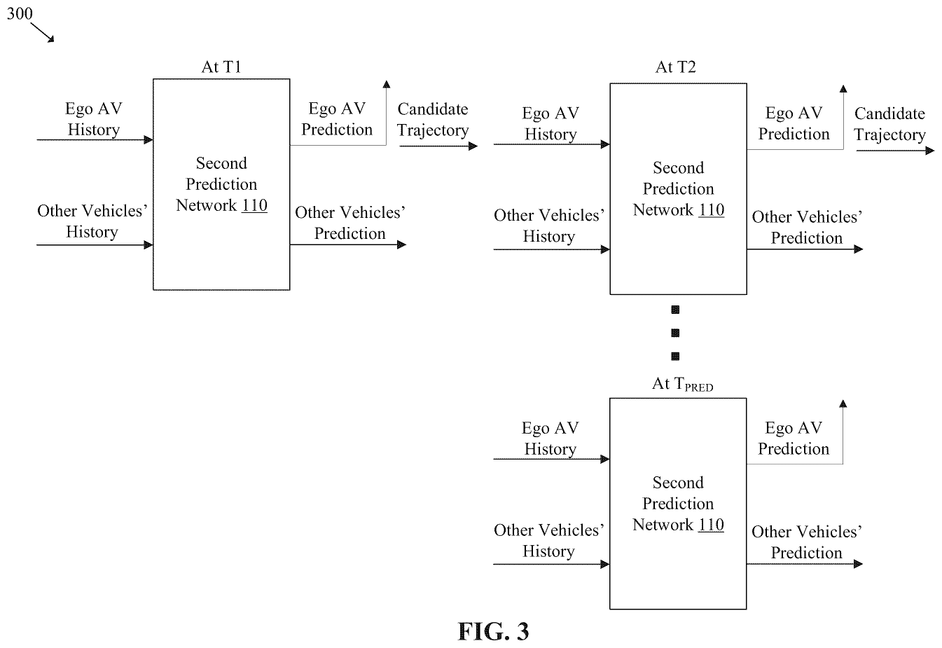

The functions or operations executed by the electronic device 102, as described in FIG. 1, may be performed by the circuitry 202. Operations executed by the circuitry 202 are described in detail, for example, in the FIGS. 3, 4, and 5.

FIG. 3 is a diagram that illustrates an exemplary teacher prediction network for generation of a set of predictions associated with states of an ego AV and a set of AVs interacting with the ego AV, in accordance with an embodiment of the disclosure. FIG. 3 is explained in conjunction with elements from FIG. 1 and FIG. 2. With reference to FIG. 3, there is shown an exemplary scenario 300 including the second prediction network 110 of FIG. 1, which may function as an exemplary teacher prediction network. The second prediction network 110 (i.e., the teacher prediction network) may be pre-trained to predict, at a current time step, a state of the ego AV 112 and a state of each AV of the set of AVs 116 that are likely at a future time step relative to the current time step. The prediction may be based on states of the ego AV 112 and each AV of the set of AVs 116 at each past time step of a set of past time steps relative to the current time step.

In accordance with an embodiment, the second prediction network 110 may generate a set of predictions over a planning horizon that corresponds to a predefined time interval (T_{PLAN}). The predefined time interval may include a set of future time steps. The set of predictions may include a prediction that may be generated at a current time step (which may be represented as T₁) and predictions generated at each of the future time steps (which may be represented as T₂ . . . T_{PRED}) of the set of future time steps (apart from a last future time step). The generated set of predictions may be used to train the first prediction network 108 (i.e., a student prediction network). Once the training is complete, the second prediction network 110 may be discarded. The set of predictions may include a state of the ego AV 112 over the predefined time interval (i.e., T_{PLAN}) and a state of each AV of the set of AVs 116 that may be interacting with the ego AV 112 over the predefined time interval (i.e., T_{PLAN}).

In accordance with an embodiment, each prediction of the set of predictions may be generated for each future time step of the set of future time steps over the predefined time interval. For instance, a first prediction of the set of predictions may be generated at the current time step (i.e., T₁) for a first future time step (i.e., for T₂) of the set of future time steps. Further, a second prediction of the set of predictions may be generated at the first future time step (i.e., at T₂) for a next time step, such as, a second future time step (i.e., for T₃) of the set of future time steps. Similarly, a final prediction of the set of predictions may be generated at T_{PRED} for the last future time step (i.e., for T_{PRED+1}) of the set of future time steps. The generation of each prediction for each future time step may be based on a state of the ego AV 112 at each past time step of a set of past time steps relative to the corresponding future time step. The generation of each prediction for each future time step may be further based on a state of each AV of the set of AVs 116 at each past time step of the set of past time steps relative to the corresponding future time step. The set of past time steps my include T_{S} discrete past time steps.

With reference to FIG. 3, as shown, at the current time step (i.e., T₁), the second prediction network 110 (i.e., the teacher prediction network) may receive a state of the ego AV 112 (for example, ego AV history, as shown) at each past time step of a set of past time steps relative to the first future time step. The ego AV history may include the state (i.e., “Z”) of the ego AV 112 at each of (T₁), (T₁₋₁), . . . , and (T₁-T_{S-1}). The second prediction network 110 may further receive a state of each AV of the set of AVs 116 (for example, other vehicles' history, as shown) at each past time step of the set of past time steps relative to the first future time step. The other vehicles' history may include the state of each AV at (T₁), (T₁₋₁), . . . , and (T₁-T_{S-1}). Based on an application of the second prediction network 110 on the ego AV history and the other vehicles' history, the first prediction of the set of predictions may be generated for the first future time step. The first prediction may include a predicted state of the ego AV 112 (for example, ego AV prediction, as shown) likely at the T₂ and a predicted state of each AV of the set of AVs 116 (for example, other vehicles' prediction, as shown) likely at T₂. The ego AV prediction may be a predicted state trajectory (i.e., a candidate trajectory generated at T₁, as shown).

With reference to FIG. 3, there is further shown that at the first future time step (i.e., T₂), the second prediction network 110 (i.e., the teacher prediction network) may receive a state of the ego AV 112 (for example, ego AV history, as shown) at each past time step of a set of past time steps relative to the second future time step. The ego AV history may include the state (i.e., “Z”) of the ego AV 112 at each of (T₂), (T₂₋₁), . . . , and (T₂-T_{S-1}). The second prediction network 110 may further receive a state of each AV (for example, other vehicles' history, as shown) of the set of AVs 116 at each past time step of the set of past time steps relative to the second future time step. The other vehicles' history may include the state (i.e., “Z”) of each AV at (T₂), (T₂₋₁), . . . , and (T₂-T_{S-1}). Based on an application of the second prediction network 110 on the ego AV history and the other vehicles' history, the second prediction of the set of predictions may be generated for the second future time step. The second prediction may include a predicted state of the ego AV 112 (for example, ego AV prediction, as shown) likely at the T₃ and a predicted state of each AV of the set of AVs 116 (for example, other vehicles' prediction, as shown) likely at T₃. The ego AV prediction may be a predicted state trajectory (i.e., a candidate trajectory generated at T₂). Similarly, the final prediction, generated at T_{PRED} for the last future time step (i.e., for T_{PRED+1}), may include the predicted state of the ego AV 112 (for example, ego AV prediction, as shown) likely at the T_{PRED+1} and a predicted state of each AV of the set of AVs 116 (for example, other vehicles' prediction, as shown) likely at T_{PRED+1}.

It should be noted that the scenario 300 of FIG. 3 is for exemplary purposes and should not be construed to limit the scope of the disclosure.

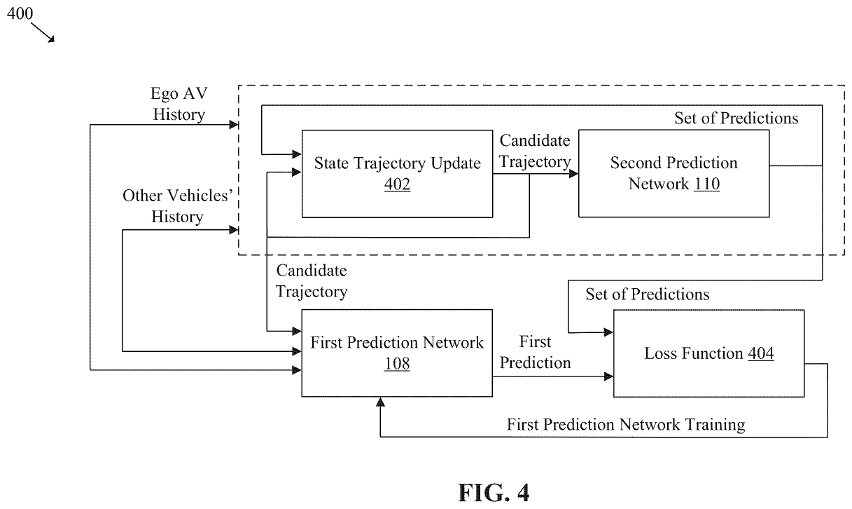

FIG. 4 is a block diagram of a scenario for exemplary knowledge distillation used for training a student prediction network using a set of predictions that may be generated by a teacher prediction network, in accordance with an embodiment of the disclosure. FIG. 4 is explained in conjunction with elements from FIG. 1, FIG. 2, and FIG. 3. With reference to FIG. 4, there is shown a block diagram of an exemplary scenario 400. In FIG. 4, there is shown the first prediction network 108 (i.e., a student prediction network) and the second prediction network 110 (i.e., a teacher prediction network) of FIG. 1. There is further shown an operation 402 that involves updating the state trajectory (i.e., the state of the ego AV 112) based on initial values and the set of predictions (see FIG. 3). There is further shown a loss function 404, based on which the student prediction network is trained.

In accordance with an embodiment, the first prediction network 108 may be trained based on knowledge distillation using the set of predictions of the pre-trained second prediction network 110. The circuitry 202 may leverage knowledge distillation to train the first prediction network 108 (i.e., the student prediction network). The knowledge distillation may involve distillation of knowledge that may be encapsulated in the teacher prediction network (i.e., the second prediction network 110) to build the student prediction network (i.e., the first prediction network 108). The knowledge distillation may enable a consolidation of learnings of the teacher prediction network within the student prediction network. The student prediction network may allow overcoming challenges (such as, computational complexity and increased latency) that may be encountered when the teacher prediction network is used for solving constrained optimization problems. The challenges may be encountered due to non-convex nature or complexity of the teacher prediction network. This may limit usage of non-linear programming in real-time applications (where latency of optimization is critical), hinder scalability, and increase reliance on heuristic methods.

Therefore, leveraging knowledge distillation enables building a smaller and compact prediction network (i.e., the student prediction network) which may efficiently predict the states of the ego AV 112 and each AV of the set of AVs 116 over a planning horizon in a single inference. The prediction of states of the ego AV 112 and each AV of the set of AVs 116, in the same inference iteration, may accelerate optimization and, thereby, facilitate scalability. The student prediction network, trained based on knowledge of the teacher prediction network, may retain problem-solving efficacy and accuracy of the teacher prediction network, and generate optimal trajectory parameters for the ego AV 112.

At 402, the state trajectory (i.e., the state of the ego AV 112) may be updated. In at least one embodiment, the circuitry 202 may update the state trajectory (i.e., the state of the ego AV 112). The update may be based on the generation, by the second prediction network 110, of the set of predictions (i.e., the ego AV prediction generated at (T₁), (T₂), . . . , and (T_{PRED})). For instance, at the current time step (i.e., at T₁), the predicted state of the ego AV 112 generated at (T₁₋₁)) may be updated as the candidate trajectory (i.e., “Z”). The second prediction network 110 may be applied on the candidate trajectory, the state (i.e., “Z”) of the ego AV 112 at each of (T₁₋₁) . . . (T₁-T_{S-1}) (for example, ego AV history, as shown), and the state of each AV of the set of AVs 116 at (T₁), (T₁₋₁), . . . , and (T₁-T_{S-1}) (for example, other vehicles' history, as shown). Based on the application, the state of the ego AV 112 at (T₂), i.e., candidate trajectory (“Z”) likely at T₂, may be predicted.

At T₂ (i.e., the first future time step), the predicted state of the ego AV 112 generated at (T₁) may be updated as the candidate trajectory (i.e., “Z”). The second prediction network 110 may be applied on the candidate trajectory, the state (i.e., “Z”) of the ego AV 112 at each of (T₂₋₁) . . . (T₂-T_{S-1}) (for example, ego AV history, as shown), and the state of each AV of the set of AVs 116 at (T₂), (T₂₋₁), . . . , and (T₂-T_{S-1}) (for example, other vehicles' history, as shown). Based on the application, the state of the ego AV 112 at (T₃), i.e., candidate trajectory (“Z”) likely at T₂ may be predicted. Similarly, at the other future time steps (such as at T₃ . . . T_{PRED}), the predicted state of the ego AV 112 generated at the previous future time steps (such as T₂ . . . T_{PRED-1}) may be updated as the candidate trajectory (i.e., “Z”).

In accordance with an embodiment, the circuitry 202 may be configured to retrieve a prediction of the set of predictions generated for a future time step of the set of future time steps. For instance, the first prediction generated at the current time step (i.e., T₁) for the first future time step (i.e., for T₂) may be retrieved. Based on the retrieval, the circuitry 202 may apply the first prediction network 108 on a set of inputs. The set of inputs may include a state of the ego AV 112 at each past time step of a set of past time steps relative to the future time step (i.e., the first future time step). Thus, the state of the ego AV 112 at each of (T₁), (T₁₋₁), . . . , and (T₁-T_{S-1}) (for example, ego AV history, as shown) may be applied as input. The set of inputs may further include a state of each AV of the set of AVs 116 at each past time step of the set of past time steps relative to the future time step (i.e., the first future time step). Thus, the state of each AV of the set of AVs 116 at each of (T₁), (T₁₋₁), . . . , and (T₁-T_{S-1}) (for example, other vehicles' history, as shown) may be applied as input. The set of inputs may further include a state of the ego AV 112 at a current time step relative to the future time step. The current time step relative to the first future time step is T₁. Therefore, the candidate trajectory at (T₁) may be received as the state of the ego AV 112 at the current time step. The predicted state of the ego AV 112 generated at (T₁₋₁) may be updated as the candidate trajectory at (T₁).

Based on the application of the first prediction network 108 on the set of inputs, a first prediction indicative of a state of the ego AV 112 for the future time step (i.e., for the first future time step or T₂) and a state of each AV of the set of AVs 116 for the future time step (i.e., for the first future time step or T₂) may be generated. The circuitry 202 may apply the loss function 404 on the generated first prediction (generated by the first prediction network 108) and the retrieved prediction of the set of predictions (generated by the second prediction network 110). The circuitry 202 may determine an outcome of the loss function 404 based on a difference between the retrieved prediction of the set of predictions and the generated first prediction. The first prediction network 108 may be trained based on the outcome such that the generated first prediction is close to the retrieved prediction. The first prediction network 108 may be, similarly, trained based on other predictions of the set of predictions generated by the second prediction network 110 for the other future time steps of the set of future time steps.

It should be noted that the scenario 400 of FIG. 4 is for exemplary purposes and should not be construed to limit the scope of the disclosure.

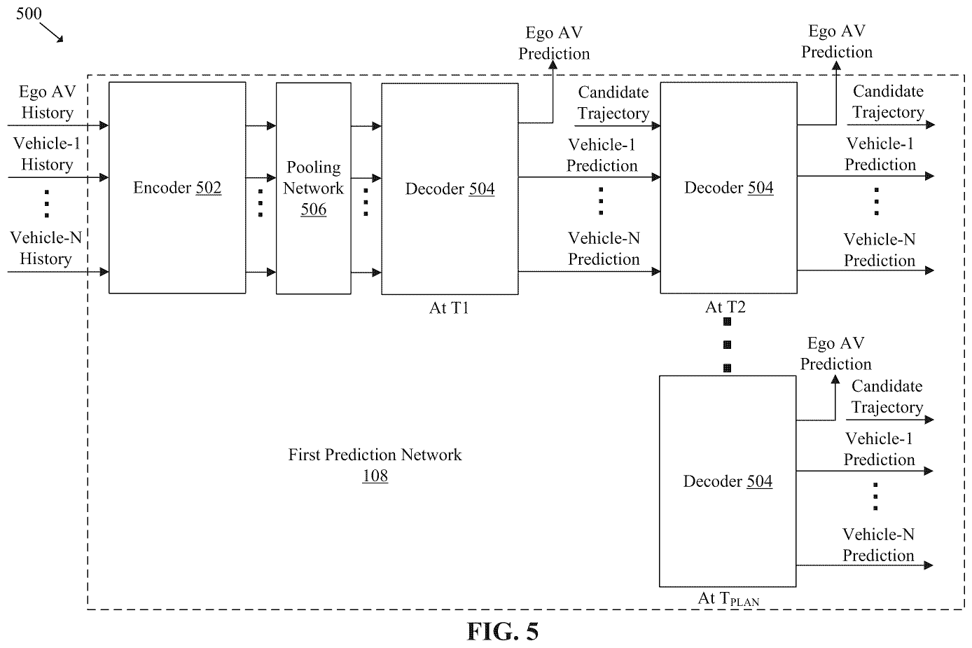

FIG. 5 is a diagram that illustrates an exemplary student prediction network for generation of predictions of a state of an ego AV and a set of AVs interacting with the ego AV over a future time interval, in accordance with an embodiment of the disclosure. FIG. 5 is explained in conjunction with elements from FIG. 1, FIG. 2, FIG. 3, and FIG. 4. With reference to FIG. 5, there is shown a block diagram of an exemplary scenario 500 of the first prediction network 108 of FIG. 1, which may function as an exemplary student prediction network.

As shown in FIG. 5, the first prediction network 108 may include an encoder 502, a decoder 504, and a pooling network 506 between the encoder 502 and the decoder 504. Each of the encoder 502 and the decoder 504 may correspond to a set of recurrent neural network (RNN) models. For example, the decoder 504 may include a set of RNN models, wherein each RNN model of the set of RNN models may be arranged in a sequential set-up such that output(s) of a previous RNN model may serve input(s) for a certain RNN model, and likewise, output(s) of the particular RNN model may be fed to a next RNN model.

As shown in FIG. 5, the encoder 502 may correspond to a neural network model that may receive inputs including a set of previous states of the ego AV 112 (for example, ego AV history, as shown) and a set of previous states of each AV of the set of AVs 116 (for example, vehicle-1 history, vehicle-2 history, . . . vehicle-N history, as shown). The circuitry 202 may apply the encoder 502 on the received inputs and generate outputs (for example, a fixed-length vector representation of the inputs), which may be fed to the pooling network 506. The pooling network 506 may correspond to a set of neural network layers that may be configured to aggregate outputs from previous convolution layers (for example, the encoder 502, in current case) and reduce spatial dimensions of the outputs of the previous convolution layer to obtain a dimensionally reduced output. The dimensionally reduced output, produced by the pooling network 506, may be fed to the decoder 504.

At time instance T₁, the decoder 504 may receive the dimensionally reduced output corresponding the fixed-length vector representation of the inputs (i.e., ego AV history, vehicle-1 history, vehicle-2 history, . . . vehicle-N history), from the pooling network 506. At T₁, the decoder 504 may generate prediction results for a next time instance T₂. The generated prediction results may include a predicted state (for example, ego AV prediction, as shown) of the ego AV 112 for the time instance T₂ and a predicted state (for example, vehicle-1 prediction, vehicle-2 prediction, . . . vehicle-N prediction, as shown) for each AV of the set of AVs 116 for the time instance T₂.

At the time instance T₂, the decoder 504 may receive an input including the ego AV prediction generated at T₁, as a candidate trajectory of the ego AV 112 for the time instance T₂. The decoder 504 may further receive inputs such as, vehicle-1 prediction, vehicle-2 prediction, . . . vehicle-N prediction, which may be generated at T₁ for the time instance T₂. Based on the received inputs, the decoder 504 may generate a predicted state (i.e., candidate trajectory for T_{S}, as shown) for the ego AV and a predicted state (i.e., vehicle-1 prediction, vehicle-2 prediction, . . . vehicle-N prediction, as shown) for each AV of the set of AVs 116, for a next time instance, such as, the time instance T₃. Similarly, at a time instance T_{PLAN} (corresponding to the planning horizon of the state prediction), the decoder 504 may receive inputs, such as, ego AV prediction (i.e., candidate trajectory), vehicle-1 prediction, vehicle-2 prediction, . . . vehicle-N prediction, based on outputs from the decoder 504 at a previous time instance T_{PLAN-1}. Based on the inputs received at the time instance T_{PLAN}, the circuitry 202 may use the decoder 504 to predict a candidate trajectory (i.e., ego AV prediction) for the ego AV 112 and a predicted state for each AV of the set of AVs 116 (i.e., vehicle-1 prediction, vehicle-2 prediction, . . . vehicle-N prediction). The predictions of the decoder 504, which may be generated at the time instance T_{PLAN}, may be for a next time instance T_{PLAN+1}.

It should be noted that the scenario 300 of FIG. 3 is for exemplary purposes and should not be construed to limit the scope of the disclosure.

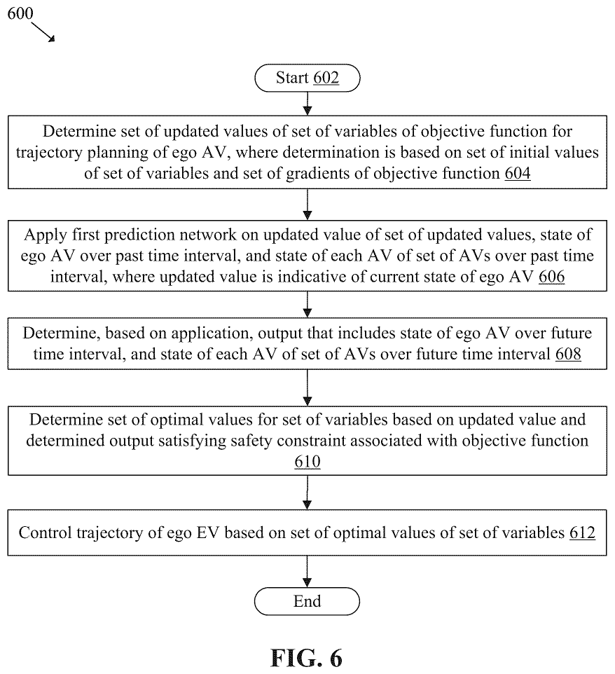

FIG. 6 is a flowchart that illustrates exemplary operations for AV trajectory planning using neural networks trained based on knowledge distillation, in accordance with an embodiment of the disclosure. With reference to FIG. 6, there is shown a flowchart 600. The flowchart 600 is described in conjunction with FIG. 1, FIG. 2, FIG. 3, FIG. 4, and FIG. 5. The operations from 602 to 612 may be implemented, for example, by the electronic device 102 of FIG. 1 or the circuitry 202 of FIG. 2. The operations of the flowchart 600 may start at 602 and proceed to 604.

At 604, the set of updated values of the set of variables of the objective function for trajectory planning of the ego AV 112 may be determined, wherein the determination may be based on each of the set of initial values of the set of variables and the set of gradients of the objective function. In one or more embodiments, the circuitry 202 may be configured to determine set of updated values of the set of variables of the objective function for trajectory planning of the ego AV 112. The determination may be based on each of the set of initial values of the set of variables and the set of gradients of the objective function. Details about the determination of the set of updated values are provided, for example, in FIGS. 1, 3, and 4.

At 606, the first prediction network 108 may be applied on an updated value of the set of updated values, a state of the ego AV 112 over a past time interval, and a state of each AV of a set of AVs 116 over the past time interval, wherein the updated value may be indicative of a current state of the ego AV 112. In one or more embodiments, the circuitry 202 may be configured to apply the first prediction network 108 on the updated value of the set of updated values, the state of the ego AV 112 over the past time interval, and the state of each AV of a set of AVs 116 over the past time interval. The updated value may be indicative of the current state of the ego AV 112. Details about the application of the first prediction network 108 are provided, for example, in FIGS. 1, 3, 4, and 5.

At 608, based on the application of the first prediction network 108, an output may be determined, wherein the output may include a state of the ego AV 112 over a future time interval, and a state of each AV of the set of AVs 116 over the future time interval. In one or more embodiments, the circuitry 202 may be configured to determine, based on the application of the first prediction network 108, the output that includes the state of the ego AV over a future time interval, and the state of each AV of the set of AVs over the future time interval. Details about the determination of the output are provided, for example, in FIGS. 1, 3, 4, and 5.

At 610, the set of optimal values for the set of variables may be determined, based on the set of updated values and the determined output satisfying a safety constraint associated with the objective function. In one or more embodiments, the circuitry 202 may be configured to determine the set of optimal values for the set of variables, based on the set of updated values and the determined output satisfying a safety constraint associated with the objective function. Details about the determination of the set of optimal values are provided, for example, in FIGS. 1 and 3.

At 612, the. In one or more embodiments, the circuitry 202 may be configured to control a trajectory of the ego AV 112 based on the set of optimal values of the set of variables. For example, a steering trajectory, an acceleration trajectory location coordinates (such as, X-Y coordinates) of the ego AV 112, a heading angle of the ego AV 112, and a speed of the ego AV 112 may be adjusted to control the trajectory of the ego AV 112. Details about control of the trajectory of the ego AV 112 are provided, for example, in FIG. 1. Control may pass to end.

Although the flowchart 600 is illustrated as discrete operations, such as 604, 606, 608, 610, and 612, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the electronic device 102) for autonomous vehicle (AV) trajectory planning using neural networks trained based on knowledge distillation. The set of instructions may be executable by the machine and/or the computer to perform operations that may include determination of a set of updated values of a set of variables of an objective function for trajectory planning of an ego AV (such as, the ego AV 112). The determination may be based on a set of initial values of the set of variables and a set of gradients of the objective function. The operations may further include application of a first prediction network (e.g., the first prediction network 108) on an updated value of the set of updated values, a state of the ego AV 112 over a past time interval, and a state of each AV of the set of AVs 116 over the past time interval. The updated value may be indicative of a current state of the ego AV 112. The operations may further include determination, based on the application, an output that includes a state of the ego AV 112 over a future time interval, and a state of each AV of the set of AVs 116 over the future time interval. The operations may further include determination of a set of optimal values based on the updated value and the determined output satisfying a safety constraint associated with the objective function. The operations may further include control of a trajectory of the ego AV 112 based on the set of optimal values of the set of variables.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. An electronic device, comprising:
circuitry configured to:
determine a set of updated values of a set of variables of an objective function for trajectory planning of an ego autonomous vehicle (AV), wherein
the determination is based on a set of initial values of the set of variables and a set of gradients of the objective function;
apply a first prediction network on an updated value of the set of updated values, a state of the ego AV over a past time interval, and a state of each AV of a set of AVs over the past time interval, wherein
the updated value is indicative of a current state of the ego AV;
determine, based on the application, an output that includes a state of the ego AV over a future time interval, and a state of each AV of the set of AVs over the future time interval;
determine a set of optimal values for the set of variables based on the updated value and the determined output satisfying a safety constraint associated with the objective function; and
control a trajectory of the ego AV based on the set of optimal values of the set of variables.

2. The electronic device according to claim 1, wherein the set of variables includes at least one of a steering trajectory, an acceleration trajectory, or a state of the ego AV.

3. The electronic device according to claim 1, wherein a state of the ego AV includes at least one of location coordinates of the ego AV, a heading angle of the ego AV, or a speed of the ego AV.

4. The electronic device according to claim 1, wherein the circuitry is further configured to:
compute the set of gradients of the objective function, wherein
a first gradient of the set of gradients is determined with respect to a first variable of the set of variables; and
a first updated value of the set of updated values of the first variable is determined based on an initial value of the set of initial values of the first variable and the first gradient of the set of gradients determined with respect to the first variable.

5. The electronic device according to claim 1, wherein
the first prediction network is trained based on knowledge distillation using a set of predictions of a pre-trained second prediction network, and
the set of predictions includes a state of the ego AV over a predefined time interval and a state of each AV of the set of AVs interacting with the ego AV over the predefined time interval.

6. The electronic device according to claim 5, wherein
each prediction of the set of predictions is generated for each future time step of a set of future time steps over the predefined time interval, and
the generation of each prediction for each future time step is based on:
a state of the ego AV at each past time step of a set of past time steps relative to the corresponding future time step, and
a state of each AV of the set of AVs at each past time step of the set of past time steps relative to the corresponding future time step.

7. The electronic device according to claim 6, wherein the circuitry is further configured to:
retrieve a prediction of the set of predictions generated for a future time step of the set of future time steps;
apply the first prediction network on a set of inputs based on the retrieval, wherein the set of inputs include:
a state of the ego AV at each past time step of a set of past time steps relative to the future time step,
a state of each AV of the set of AVs at each past time step of the set of past time steps relative to the future time step, and
a state of the ego AV at a current time step relative to the future time step;
generate, based on the application of the first prediction network on the set of inputs, a first prediction indicative of a state of the ego AV for the future time step and a state of each AV of the set of AVs for the future time step; and
determine an outcome of a loss function based on a difference between the retrieved prediction and the generated first prediction, wherein
the first prediction network is trained based on the outcome.

8. The electronic device according to claim 1, wherein
the first prediction network includes an encoder model and a decoder model, and
each of the encoder model and the decoder model includes a set of recurrent neural network models.

9. The electronic device according to claim 8, wherein the circuitry is further configured to:
apply the encoder model on the updated value of the set of updated values, the state of the ego AV over the past time interval, and the state of each AV of the set of AVs over the past time interval, wherein
the state of the ego AV over the past time interval corresponds to a state of the ego AV at each past time step of a set of past time steps over the past time interval, and
the state of each AV of the set of AVs over the past time interval corresponds to a state of the corresponding AV at each past time step of the set of past time steps over the past time interval.

10. The electronic device according to claim 8, wherein
the determined output corresponds to an output of the decoder model,
the state of the ego AV over the future time interval includes a state of the ego AV at each future time step of a set of future time steps over the future time interval, and
the state of each AV of the set of AVs over the future time interval corresponds to a state of the corresponding AV at each future time step of the set of future time steps over the future time interval.

11. The electronic device according to claim 10, wherein the circuitry is further configured to:
apply the decoder model on a state of the ego AV at a first future time step of the set of future time steps and a state of each AV of the set of AVs at the first future time step of the set of future time steps; and
generate, as an output of the decoder model, a state of the ego AV at a second future time step of the set of future time steps and a state of each AV of the set of AVs at the second future time step of the set of future time steps.

12. A method, comprising:
in an electronic device:
determining a set of updated values of a set of variables of an objective function for trajectory planning of an ego autonomous vehicle (AV), wherein
the determination is based on a set of initial values of the set of variables and a set of gradients of the objective function;
applying a first prediction network on an updated value of the set of updated values, a state of the ego AV over a past time interval, and a state of each AV of a set of AVs over the past time interval, wherein
the updated value is indicative of a current state of the ego AV;
determining, based on the application, an output that includes a state of the ego AV over a future time interval, and a state of each AV of the set of AVs over the future time interval;
determining a set of optimal values for the set of variables based on the updated value and the determined output satisfying a safety constraint associated with the objective function; and
controlling a trajectory of the ego AV based on the set of optimal values of the set of variables.

13. The method according to claim 12, wherein the set of variables includes at least one of a steering trajectory, an acceleration trajectory, or a state of the ego AV.

14. The method according to claim 12, wherein:
the first prediction network is trained based on knowledge distillation using a set of predictions of a pre-trained second prediction network,
the set of predictions includes a state of the ego AV over a predefined time interval and a state of each AV of the set of AVs interacting with the ego AV over a predefined time interval.

15. The method according to claim 14, wherein:
each prediction of the set of predictions is generated for each future time step of a set of future time steps over the predefined time interval, and
the generation of each prediction for each future time step is based on:
a state of the ego AV at a set of past time steps relative to the corresponding future time step, and
a state of each AV of the set of AVs at the set of past time steps relative to the corresponding future time step.

16. The method according to claim 12, wherein
the first prediction network includes an encoder model and a decoder model, and
each of the encoder model and the decoder model includes a set of recurrent neural network models.

17. The method according to claim 16, further comprising:
applying the encoder model on the updated value of the set of updated values, the state of the ego AV over the past time interval, and the state of each AV of the set of AVs over the past time interval, wherein
the state of the ego AV over the past time interval corresponds to a state of the ego AV at each past time step of a set of past time steps over the past time interval, and
the state of each AV of the set of AVs over the past time interval corresponds to a state of the corresponding AV at each past time step of the set of past time steps over the past time interval.

18. The method according to claim 16, wherein
the determined output corresponds to an output of the decoder model,
the state of the ego AV over the future time interval includes a state of the ego AV at each future time step of a set of future time steps over the future time interval, and
the state of each AV of the set of AVs over the future time interval corresponds to a state of the corresponding AV at each future time step of the set of future time steps over the future time interval.

19. The method according to claim 18, further comprising:
applying the decoder model on a state of the ego AV at a first future time step of the set of future time steps and a state of each AV of the set of AVs at the first future time step of the set of future time steps; and
generating, as an output of the decoder model, a state of the ego AV at a second future time step of the set of future time steps and a state of each AV of the set of AVs at the second future time step of the set of future time steps.

20. A non-transitory computer-readable medium having stored thereon, computer-executable instructions that when executed by an electronic device, causes the electronic device to execute operations, the operations comprising:
determining a set of updated values of a set of variables of an objective function for trajectory planning of an ego autonomous vehicle (AV), wherein
the determination is based on a set of initial values of the set of variables and a set of gradients of the objective function;
applying a first prediction network on an updated value of the set of updated values, a state of the ego AV over a past time interval, and a state of each AV of a set of AVs over the past time interval, wherein
the updated value is indicative of a current state of the ego AV;
determining, based on the application, an output that includes a state of the ego AV over a future time interval, and a state of each AV of the set of AVs over the future time interval;
determining a set of optimal values for the set of variables based on the updated value and the determined output satisfying a safety constraint associated with the objective function; and
controlling a trajectory of the ego AV based on the set of optimal values of the set of variables.
